(19) United States
(12) Patent Application Publication
(10) Pub. No.: US 2015/0283933 A1
(43) Pub. Date: Oct. 8, 2015

(54) STOW LIFT SYSTEM FOR A VEHICLE WITH A MOVABLE REAR IMPACT GUARD

(71) Applicant: JANA NV, Belsele (BE)

(72) Inventors: Pol DERIE, Belsele (BE); Jan DHOLLANDER, Lokeren (BE)

(73) Assignee: JANA NV, Belsele (BE)

(21) Appl. No.: 14/244,361

(22) Filed: Apr. 3, 2014

(51) Int. Cl. B60P 1/44; B60R 19/48

(52) U.S. Cl. CPC B60P 1/445; B60R 19/48

(57) ABSTRACT

The present invention relates to a stow lift system for a vehicle comprising a support frame for mounting the lift system to a vehicle, a foldable lift platform and a rear impact guard, which is arranged to be held in the extended position by a holding mechanism. An actuator is further provided for actuating the first connecting mechanism such as to move the platform between first position and a second position. The first connecting mechanism comprises an engagement mechanism arranged for engaging at least one predetermined location of the rear impact guard such that the actuating force generated by the actuator during the movement of the platform is transferred to the rear impact guard so as to overcome the holding force applied to the rear impact guard by the holding mechanism and move the rear impact guard from the extending position to the retracted position.

### TECHNICAL FIELD

The present invention relates to a stow lift system for a vehicle with a movable rear impact guard. The present invention further relates to a vehicle equipped with such a stow lift system and to a system for locking the position of the vehicle with respect to a loading bay of a storage facility.

### BACKGROUND ART

Stow lift systems, often also referred to also as fold-away lift gate systems, are typically mounted to a support frame at the rear of a vehicle, e.g a truck, trailer or a semi-trailer, to lift payloads on a lift platform between a first level, e.g. where the lift platform is flush with the vehicle bed, referred to also as vehicle loading surface, and a second level, e.g. where the lift platform is flush with the ground, or vice versa. A common type of a stow lift system may include a foldable lift platform, which when not in use, is folded under the vehicle bed, while when needed can be unfolded to create a loading surface. The foldable lift platform may be coupled to the support frame by means of a first connecting mechanism, which first connecting mechanism is movable by means of an actuator mechanism for actuating the lift platform of the stow lift system between the first level and second level.

A rear impact guard may be further provided at the rear of the vehicle for preventing, in the case of a rear impact collision, the colliding vehicle from driving on the underside of the vehicle bed. The rear impact guard of the vehicle may further function as a mechanism for locking the position of the vehicle with respect to a loading bay, during the loading and unloading of products by means for example of fork lifts or electric pallet jacks between the loading bay and the vehicle bed. In this case, the rear impact guard may be arranged to cooperate with a dock lock system of a loading bay so as to prevent the vehicle from moving or seesawing during loading and unloading of the products. Usually, the rear impact guard is mounted at the rear of the vehicle chassis, and is usually arranged to be in the extending position so that during the loading and unloading of products between the loading bay and the vehicle, or vice versa, it can be engaged by the dock lock system of the loading bay. However, when the foldable lift platform is used for loading or unloading products from the ground level, the rear impact guard should be movable between the extended position and a retracted position such that the movement of the foldable lift platform between the first level and second level is not restricted.

U.S. Pat. No. 7,762,756 presents a stow lift system with a rear impact guard that can be moved between the extended position and the retracted position so as to accommodate the movement of the foldable lift platform. However, the stow lift system presented in U.S. Pat. No. 7,762,756 has the disadvantage in that the rear impact guard and the foldable lift platform are directly connected and thereby are arranged to function as one unit. As such, the rear impact guard essentially co-revolves with the foldable lift platform about the support frame axis by the action of the actuators. As a result, in the case where the foldable lift platform is used in combination with a loading bay, e.g. for loading and unloading products between the vehicle and the loading bay, positioning the foldable lift platform at the first level, such that it is flush with the vehicle loading surface may cause the rear impact guard to be moved out of the extended position thereby preventing the locking of the vehicle position using the dock lock system, resulting in the violation of the safety regulations with regards to the loading and unloading of products between a loading bay and a vehicle. Moreover, in the event of a rear impact collision, the force generated during the impact at the rear impact guard will be transferred to the common connecting mechanisms of the stow lift system, which may lead to the damage and possible replacement of the complete stow lift system.

### BRIEF SUMMARY OF THE INVENTION

It is an aim of the present invention to provide a stow lift system, also referred to as fold-away lift gate system, with a movable rear impact guard that may be used with a vehicle, such as a truck, a trailer or a semi-trailer.

This aim is achieved according to the invention with the lift system showing the technical characteristics of the first claim.

According to embodiments of the present invention, a stow lift system for a vehicle is provided. The stow lift system comprises a support frame for mounting the lift to the vehicle and a foldable lift platform coupled to the support frame via a first connecting mechanism of the lift system. An actuator may be provided for actuating the first connecting mechanism such that the foldable lift platform can be moved via the first connecting mechanism between a stowed position and an unstowed position. The actuator may be further arranged to move the foldable lift platform when in the unstowed position between the ground level and a vehicle bed level. The stow lift system may be further provided with a rear impact guard comprising a longitudinal support member, which is coupled to the support frame via a second connecting mechanism of the lift system. A holding mechanism of the lift system may be arranged between the support frame and the rear impact guard for applying a holding force on the rear impact guard for holding the rear impact guard in an extended position. The rear impact guard may be arranged to move from the extended position to a retracted position when the foldable lift platform is lowered below the level of the rear impact guard, the rear impact guard being reversibly movable between the retracted position and the extended position when the foldable lift platform is raised above the level of the rear impact guard. The first connecting mechanism may further comprise an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position.

According to embodiments of the present invention, the engagement mechanism is arranged to only engage the rear impact guard at a predetermined moment during the movement of the foldable lift platform. For example, the engagement mechanism may be arranged to engage the rear impact guard at the moment when the foldable lift platform is at the same level with the rear impact guard. Therefore, the movement of the rear impact guard is not entirely coupled to the movement of the foldable lift platform. This arrangement of the foldable lift platform and the rear impact guard may have as an advantage that positioning the lift platform at a certain level, e.g. when the foldable lift platform is flush with the vehicle loading surface, may not influence the position of the rear impact guard with respect to the dock lock system. As a result, the present invention allows for the position of the vehicle to be locked with respect to the loading bay using a dock lock system, even when the foldable platform is used for loading and unloading products between a vehicle and the loading bay of a storage facility. Moreover, since the engagement mechanism and the rear impact guard are not attached to one another via common connecting elements, in the event of a rear collision the force transferred from the rear impact guard to the first connecting mechanism holding the foldable lift platform may be significantly reduced, thereby reducing the risk of completely damaging the stow lift system.

According to embodiments of the present invention, a system for locking the position of a vehicle with respect to a loading bay may be provided. The system comprises a vehicle comprising a stow lift system according to embodiments of the present invention and a loading bay. The loading bay comprising a dock lock system, wherein the dock lock system is arranged to cooperate with the rear impact guard of the stow lift system so as to lock the position of the vehicle with respect to the loading bay.

### BRIEF DESCRIPTION OF THE DRAWINGS

The invention will be further elucidated by means of the following description and the appended figures.

FIG. 1 shows a perspective view of a stow lift system according to embodiments of the present invention in the stowed position.

FIG. 2 shows a perspective view of the stow lift system according to embodiments of the present invention moving in a first step out of the stowed position.

FIG. 3 shows a perspective view of the stow lift system according to embodiments of the present invention moving in a second step out of the stowed position.

FIG. 4 shows a perspective view of the stow lift system according to embodiments of the present invention moving in a third step to the unstowed position.

FIG. 5 shows a perspective view of the stow lift system according to embodiments of the present invention with the foldable lift platform raised to the vehicle bed level.

FIG. 6 shows a close up view of the stow lift system in the position of FIG. 5.

FIG. 7 shows a perspective view of the stow lift system according to embodiments of the present invention with the lift platform positioned at the level of the rear impact guard.

FIG. 8 shows a close up view of the stow lift system at the position shown in FIG. 7.

FIG. 9 shows a further close up view of the stow lift system at the position shown in FIG. 7.

FIG. 10 shows a perspective view of the stow lift system according to embodiments of the present invention with the rear impact guard moving to the retracted position.

FIG. 11 shows a perspective view of the stow lift system according to embodiments of the present invention with the lift platform at ground level and the rear impact guard in the retracted position.

FIG. 12 shows a perspective view of the lift system in the position shown in FIG. 11.

FIG. 13 shows a vehicle equipped with a stow lift system according to embodiments of the present invention with the rear impact guard cooperating with the dock lock system of a loading bay.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B. The term stow lift system may be considered to include any lift gate system that can be folded away when not in use.

The term vehicle may be considered to include any vehicle which can be fitted with the stow lift system of present invention, such as a truck, a trailer or a semi-trailer.

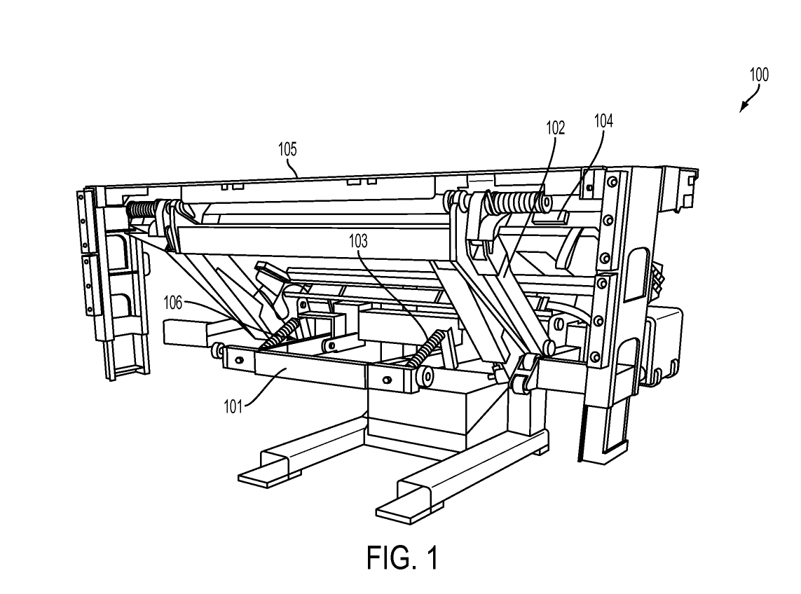

Referring to FIGS. 1 to 13 a stow lift system 100 according to embodiments of the present invention is provided for use with a vehicle 201, such as a truck. The stow lift system 100 may be provided with a support frame 107 for mounting the stow lift system 100 to a predetermined location on the vehicle 201 e.g. at the rear of the vehicle 201. The stow lift system 100 may comprise a foldable lift platform 104, which is coupled to the support frame 107 via a first connecting mechanism 102 of the stow lift system 100. The first connecting mechanism may comprise a first and a second support member transversely connected at one end to the support frame and to the other end to a longitudinal support member. The foldable lift platform 104 may be coupled to the first connecting mechanism 102 via the longitudinal support member of the first connecting mechanism 102. The first connecting mechanism 102 may be arranged to move the foldable lift platform 104 from the stowed (folded) position to the unstowed position (unfolded) and vice versa. To provide the necessary actuating force to the first connecting mechanism 102 for moving the foldable lift platform 104 between a stowed and unstowed position, an actuator 109 may be provided. The actuator 109 may be further arranged to move the foldable lift platform 104 when in the unstowed position between the ground level and a vehicle bed level. The stow lift system 100 may be further provided with a rear impact guard 101 comprising a longitudinal support member, which is coupled to the support frame 107 via a second connecting mechanism 106 of the stow lift system 100. A holding mechanism 103 of the lift system may be arranged between the support frame 107 and the rear impact guard 101 for applying a holding force on the rear impact guard 101 for holding the rear impact guard 101 in an extended position. The rear impact guard 101 may be arranged to move between the extended position corresponding to the stowed position of the foldable lift platform 104 and a retracted position corresponding to the unstowed position of the foldable lift platform 104. The rear impact guard 101 may be arranged to move from the extended position to a retracted position when the foldable lift platform 104 is lowered below the level of the rear impact guard 101. The rear impact guard may be reversibly movable between the retracted position and the extended position when the foldable lift platform 104 is raised above the level of the rear impact guard 101.

In order to move the rear impact guard 101 from the extended position to the retracted position, an engagement mechanism 110 may be provided on the first connecting mechanism 102. The engagement mechanism 110 may be arranged to engage at least one location of the rear impact guard 101 at a predetermine moment during the movement of the foldable lift platform 104 between the stowed and unstowed position. For example, the engagement mechanism 110 may be arranged to engage the rear impact guard 101 when the foldable lift platform 104 is at a predetermined level with respect to the rear impact guard 101. Therefore, the rear impact guard 101 may be moved from the extended position to the retracted position by the actuating force generated by the actuator 109 during the movement of the foldable lift platform 104. As a result, with the stow lift system 100 of the present invention the rear impact guard 101 may be moved between the extended and retracted position or vice versa without the need of an additional actuating mechanism, which may complicate the manufacturing of the stow lift system 100 and significantly increase its cost. Furthermore, the arrangement between the engagement mechanism 104 and the rear impact guard 101 may enable the use of the stow lift system 104 for loading and unloading products between a vehicle bed 105 and a loading bay 203 of a storage facility 202, without preventing for the position of the vehicle 201 to be locked with respect to the loading bay 203 using a dock lock system 204.

FIG. 1 shows the stow lift system 100 according to embodiments of the present invention with the foldable lift platform 104 in the stowed position. As shown in FIG. 1 the stowed lift system 100, when in the stowed positioned, may be stored under the vehicle bed 105 while the rear impact guard 101 is maintained in the extended position so as to prevent colliding vehicles from driving on the underside of the vehicle bed 105. The rear impact guard 101 may be maintained in the extended position by means of a holding mechanism attached at one end to the longitudinal support member of the rear impact guard 101 and at the other end to the support frame 107. The holding mechanism 103 may be positioned on the longitudinal support member of the rear impact guard 101 at a location near each of the longitudinal support member ends. For example the holding mechanism 103 may comprise tension springs, which are arranged for holding the rear impact guard in the extended position. The tension springs may be of a helical or coil type, although other types of springs may be equally used.

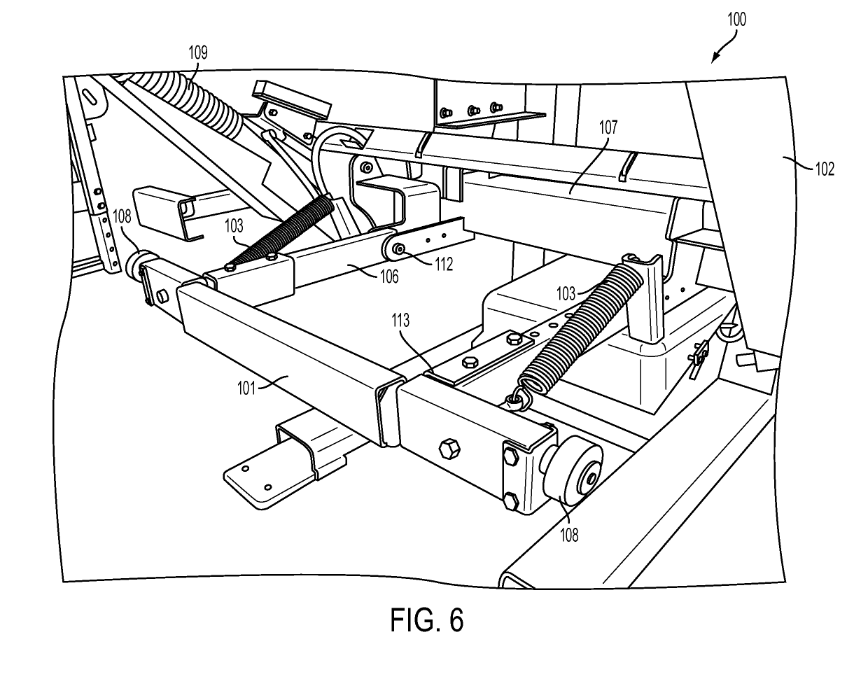

According to embodiments of the present invention, the longitudinal member of the rear impact guard 101 may be pivotally mounted to the support frame 107 via a second connecting mechanism 106, such that it can be moved from the extended position to the retracted position and vice versa. For example, the second connecting mechanism 106 may comprise at least one hinge 112 for pivotally mounting the longitudinal support member of the rear impact guard 101 to the support frame 107, as shown in FIG. 6. The at least one hinge 112 may be provided for limiting the range of motion of the rear impact guard 101 with respect to a first plane. For example, the at least one hinge 112 may allow the longitudinal support member of the rear impact guard 101 to move by up to 90° degrees about a first plane. As shown in FIG. 6, the second connecting mechanism 106 may be further connected to the longitudinal support member via adjustable brackets 113, which are arranged for adjusting the distance of the longitudinal support member from the support frame 107 depending on the height of the vehicle bed 105. As shown in FIGS. 1 to 12, the second connecting mechanism 106 may comprise two support members, which may be transversely connected at one end to the longitudinal support member of the rear impact guard 101 via the adjustable brackets 113 and to the support frame 107 at the other end via the at least one hinge 112. In order to save space and spare parts, it is possible to transversely connected a single support member to the longitudinal support member of the rear impact guard 101.

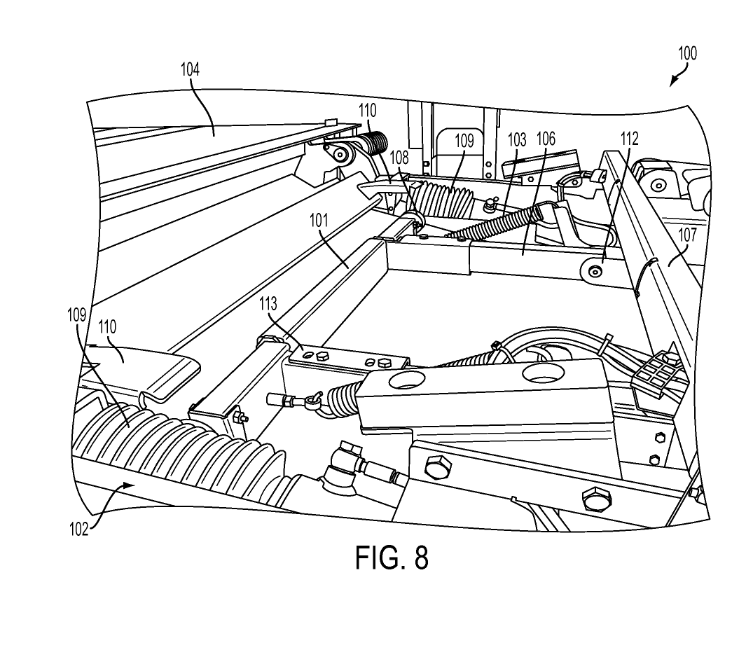

According to embodiments of the present invention, the rear impact guard 101 may comprise contact members 108 arranged to be engaged by the engagement mechanism 110 of the foldable lift platform 104, as shown in FIG. 8. For example, the contact members 108 may be provided at each end of the longitudinal support member of the rear impact guard 101. On the other hand, the engagement mechanism 110 may comprise protruding members extending outwardly from the longitudinal support member of the first connecting mechanism 102 arranged for engaging the rear impact guard 101 at the location of the contact members 108. The contact members 108 of the rear impact guard 101 may be provided with a surface having a shape matching the shape of a corresponding surface on the protruding members of the engagement mechanism 110. For example the contact members 108 may be provided with a surface having an outer convex shape, e.g. the contact member may be a wheel, while the protruding members of the engagement mechanism 110 may be provided with a concave surface arranged to cooperate with the convex surface of the contact members 108.

The operation of the stow lift platform will now be described with references FIGS. 1 to 12, which shows different examples of the stow lift system 100 according to embodiments of the present invention with the foldable lift platform 104 at different positions.

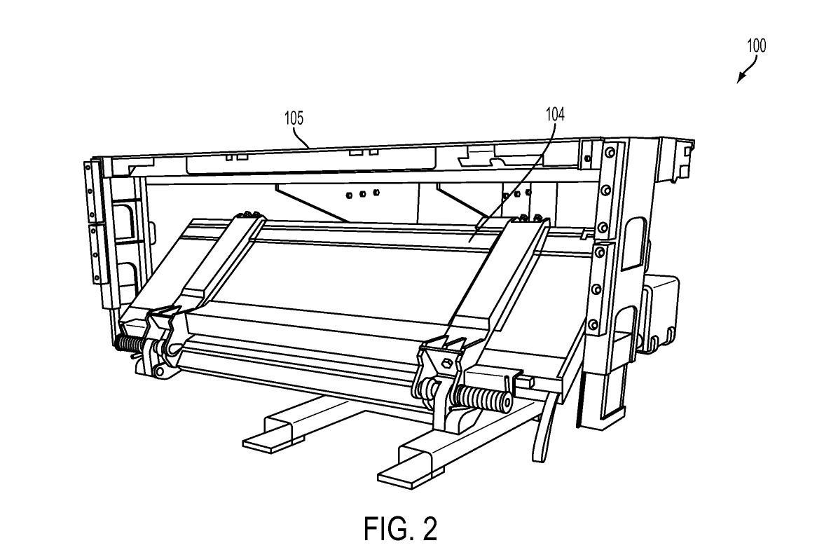

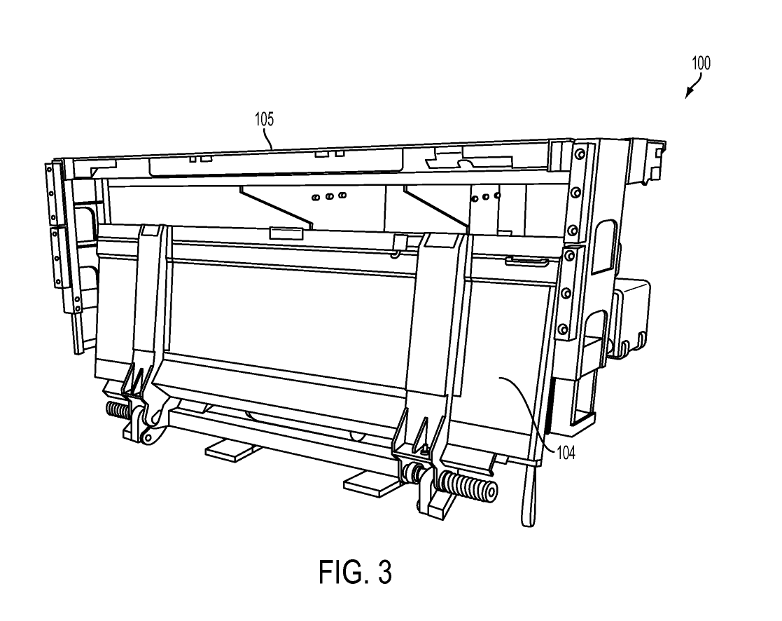

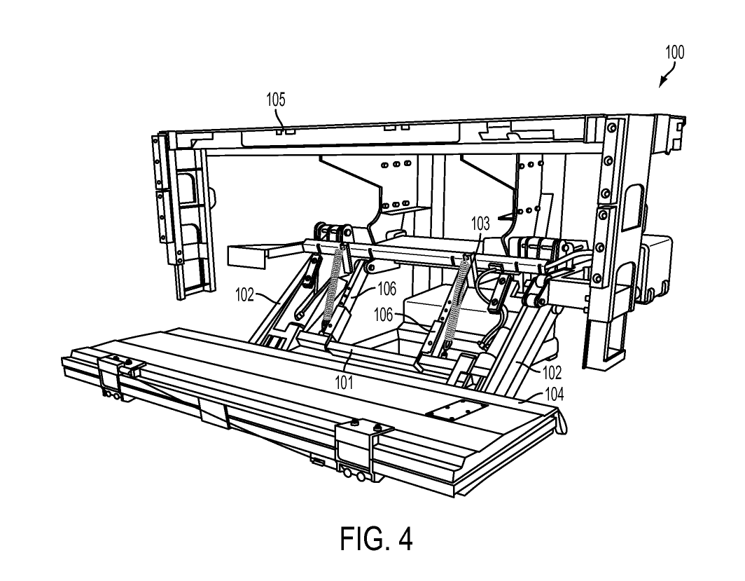

Starting from the stowed position, as shown in FIG. 1, the foldable lift platform 104 may be moved by the actuators 109 of the stow lift system 100 towards the ground level such that the foldable lift platform 104 can be unfolded without coming in contact with the vehicle bed 105, as shown in FIGS. 2 and 3. FIG. 4 shows the interaction between the foldable lift platform 104 and the rear impact guard 101, when the foldable lift platform is in the unstowed position. As shown in FIG. 4, in the unstowed position the engagement mechanism 110 may be engaged with the contact members 108 of the rear impact guard 101. As a result, the rear impact guard 101 may be moved from the extended position, shown in FIG. 1, to the retracted position by the actuating force generated by the actuator 109 during the movement of the foldable lift platform 104.

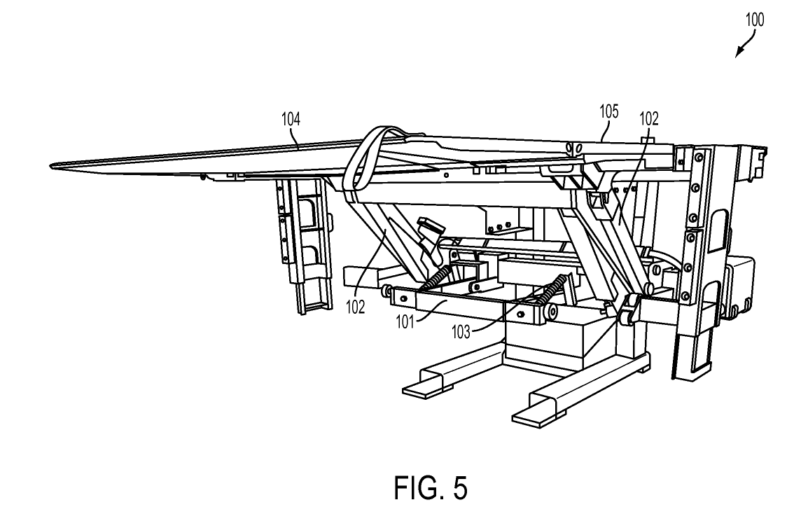

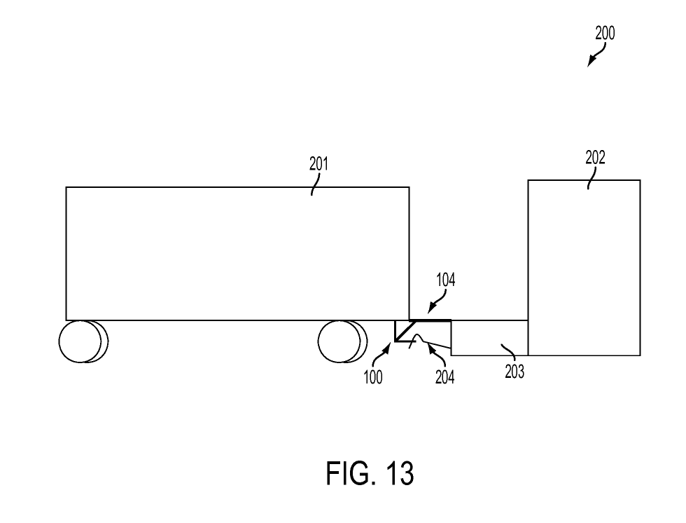

The foldable lift platform 104 may be completely unfolded to form a loading surface for loading and unloading products to and from the vehicle bed 105. FIGS. 5 and 6 show the foldable lift platform 104 positioned via the actuators 109 to a first level corresponding to the vehicle bed 105. At the first level, the rear impact guard may be in the extended position since the engagement mechanism 110 of the foldable lift platform 104 does not engage the contact members of the rear impact guard 101. As a result, the stow lift system 100 according to embodiments of the present invention may be used for loading and unloading products between the vehicle bed 105 and the loading bay 203 without preventing the locking of the position of the vehicle 201 with respect to a loading bay 203 using a dock lock system 204, as shown in FIG. 13.

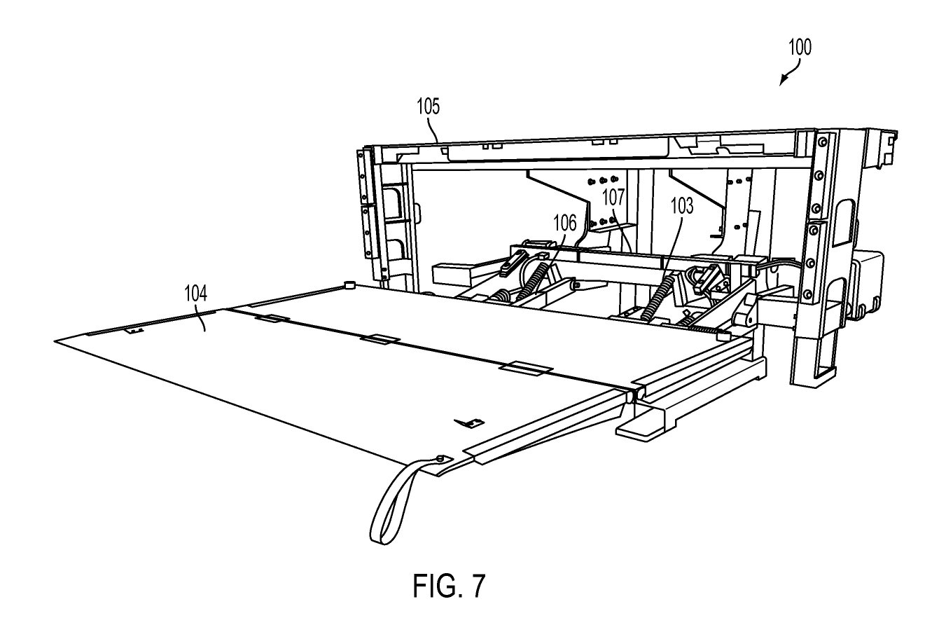

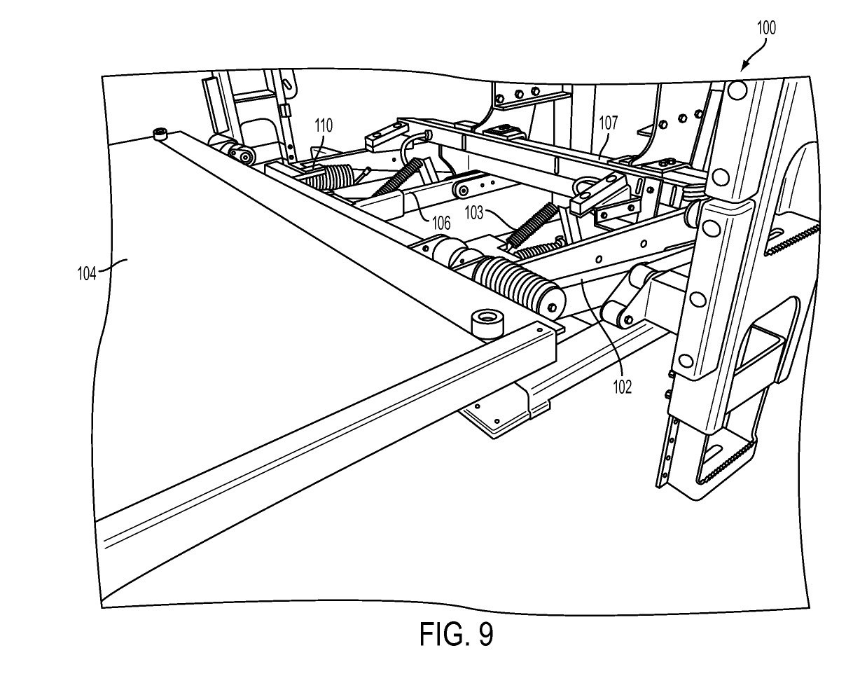

In order to load or unload products from the ground level, the foldable lift platform 104 may be moved from the first level, corresponding to the vehicle bed 105, towards a second level, corresponding to the ground level, such that products can be transferred between the vehicle bed 105 and the ground level. FIG. 7 shows the lift platform at an intermediate level between the vehicle bed 105 and the ground level. At the position shown in FIG. 7, the engagement mechanism 110 may not be engaged with the contact member 108 of the rear impact guard. As a result, the rear impact guard is maintained at the extended position as shown in FIGS. 8 and 9.

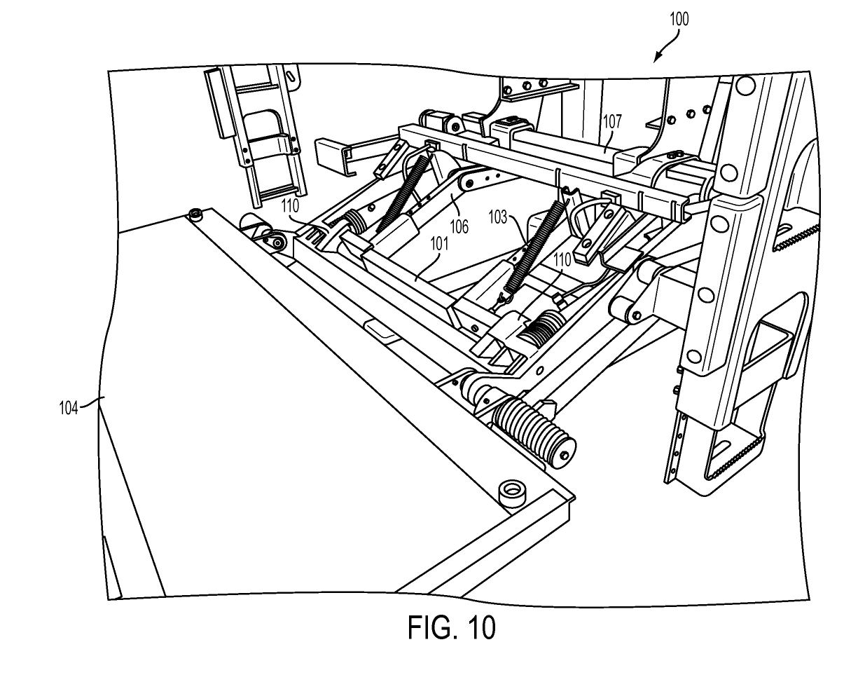

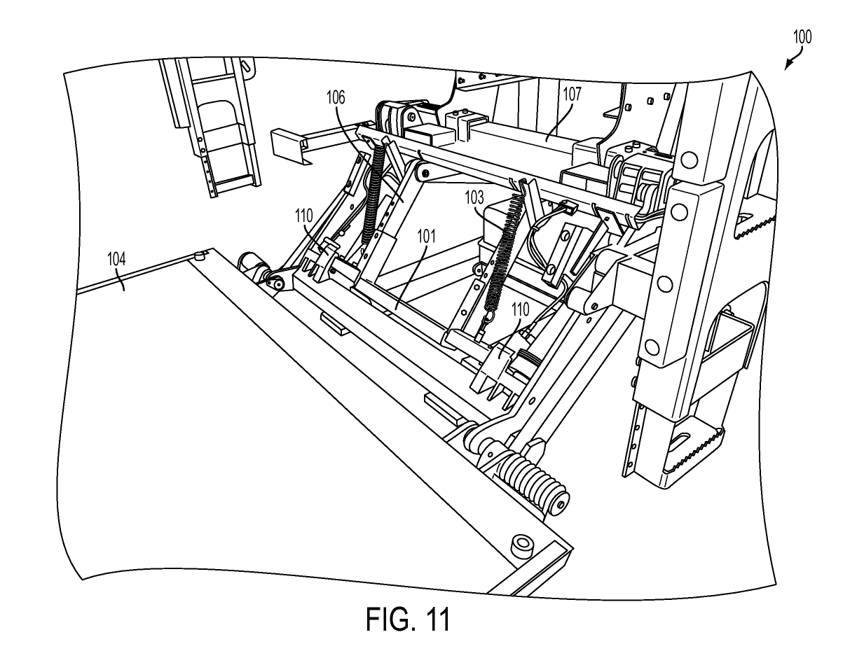

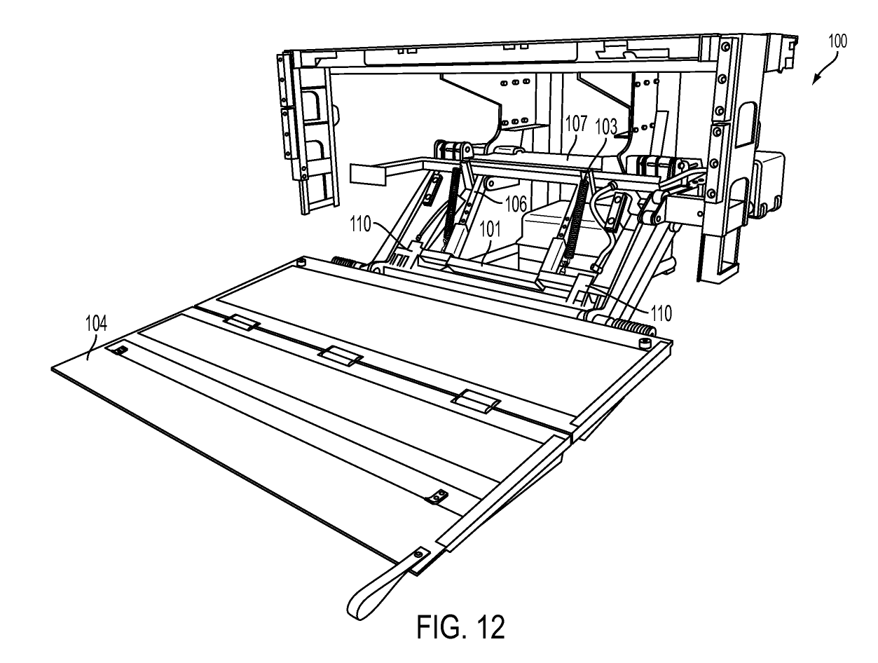

Once the engagement mechanism 110 comes into contact with the contact members 108 of the rear impact guard 101 the actuating force generated by the actuators 109 during the movement of the foldable lift platform 104 may be transferred to the rear impact guard 101 so as to overcome the holding force applied to the rear impact guard 101 by the holding mechanism 103 and move the rear impact guard 101 from the extending position to the retracted position, a shown in FIGS. 10 to 11. FIG. 12 shows the foldable lift platform 104 positioned at the ground level with the rear impact guard 101 in retracted position so that it does not interfere with the movement of the foldable lift platform 104 for loading and unloading products between the vehicle bed 105 and the ground level.

According to embodiments of the present invention, a system 200 for locking the position of the vehicle 201 with respect to the loading bay 203 of a storage facility 202 may be provided, as shown in FIG. 13. The system may comprise a vehicle 201 comprising a stow lift system 100 according to embodiments of the present invention. For example, the stow lift system 100 may provided at the rear of the vehicle 201 and may further be arranged such that when in the stow position it is tucked under the vehicle bed 105. The system 200 may further comprise a loading bay 203 of a storage facility 201, which loading bay 203 may be provided with a dock lock system 204 arranged to cooperate with the rear impact guard 101 of the stow lift system 100 so as to lock the position of the vehicle 201 with respect to the loading bay 203. The dock lock system 204 may be provided at one end with a locking mechanism arranged to engage the rear impact guard 101 at the location of the longitudinal support member so as to lock the position of the vehicle 201 with respect to the loading bay 203. For example, the locking mechanism of the dock lock system 204 may have a hook shape such that it grips around the longitudinal support member of the rear impact guard 101.

In order to lock the position of a vehicle 201 fitted with a stow lift system 100 according to embodiments of the present invention with respect to the respect to a loading bay 203, the vehicle 201 may be first positioned with the rear end at a predetermined distance from the loading bay 203. A dock lock system 204 may be provided at the loading bay 203 having at one end a locking mechanism. The locking mechanism may be positioned to the longitudinal support member of the rear impact guard 101 of the stow lift system 100 such that the position of the vehicle 201 with respect to the loading bay 203 is locked during the loading and unloading of products between the loading bay 203 and the vehicle 201 and vice versa.

1. A stow lift system for a vehicle, the lift system comprising
a support frame for mounting the lift system to a vehicle;
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed;
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard;
an actuator for actuating the first connecting mechanism such as to move the platform between the stowed position and the unstowed position, the actuator being further arranged to move the foldable lift platform between the vehicle bed and the ground level;
wherein the first connecting mechanism comprises an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position.

2. The stow lift system of claim 1, wherein the holding mechanism is attached at one end to the longitudinal support member of the rear impact guard and at the other end to the support frame.

3. The stow lift system of claim 2, wherein the holding mechanism comprises at least one tension spring arranged for holding the rear impact guard in the extended position.

4. The stow lift system of claim 3, wherein the holding mechanism comprises at least one helical spring.

5. The stow lift system of claim 3, wherein the holding mechanism comprises at least one coil spring.

6. The stow lift system of claim 1, wherein the longitudinal support member of the rear impact guard is pivotally mounted to the support frame via the second connecting mechanism.

7. The stow lift system of claim 6, wherein the second connecting mechanism comprises at least one hinge arranged for pivotally mounting the longitudinal support member of the rear impact guard to the support frame.

8. The stow lift system of claim 7, wherein the second connecting mechanism comprises at least one support member transversely connected at one end to the longitudinal support member of the rear impact guard and to the support frame at the other end via the at least one hinge.

9. The stow lift system of claim 7, wherein the at least one support member of the second connecting mechanism is connected to the longitudinal support member via an adjustable bracket arranged for adjusting the distance of the longitudinal support member from the support frame.

10. The stow lift system of claim 1, wherein the rear impact guard comprises contact members arranged to be engaged by the engagement mechanism of the first connecting mechanism.

11. The stow lift system of claim 10, wherein the contact members of the rear impact guard are provided at each end of the longitudinal support member.

12. The stow lift system of claim 11, wherein the contact members of the rear impact guard have an outer convex surface.

13. The stow lift system of claim 12, wherein the contact members of the rear impact guard comprises at least one wheel having an outer convex surface.

14. The stow lift system of claim 1, wherein the first connecting mechanism comprises at least two support members each transversely connected at one end to the support frame and to the other end to a longitudinal support member.

15. The stow lift system of claim 1, wherein the engagement member comprises protruding members extending outwardly from the longitudinal support member of the first connecting mechanism arranged for engaging the rear impact guard at the location of the contact members.

16. The stow lift system of claim 15, wherein the protruding members of the engagement mechanism comprise a concave surface arranged for engaging the outer convex surface of the contact members of the rear impact guard.

17. The stow lift system of claim 1, wherein the rear impact guard is arranged when in the extended position to cooperate with a dock lock system of a loading bay.

18. A vehicle comprising a stow lift system, the stow lift system comprising
a support frame for mounting the lift system to a vehicle,
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed,
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard,
an actuator for actuating the first connecting mechanism such as to move the platform between the stowed position and the unstowed position, the actuator being further arranged to move the foldable lift platform between the vehicle bed and the ground level,
wherein the first connecting mechanism comprises an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position.

19. The vehicle of claim 18, wherein the stow lift system is provided at the rear of the vehicle.

20. The vehicle of claim 19, wherein the stow lift system is arranged such that when in the stow position is folded under the vehicle bed.

21. The vehicle of claim 18, wherein the vehicle is a truck.

22. The vehicle of claim 18, wherein the vehicle is a trailer.

23. The vehicle of claim 18, wherein the vehicle is a semi-trailer.

24. A system for locking the position of a vehicle with respect to a loading bay, the system comprising:
a vehicle comprising a stow lift system, the stow lift system comprising
a support frame for mounting the lift system to a vehicle,
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed,
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard,
an actuator for actuating the first connecting mechanism such as to move the platform between the stowed position and the unstowed position, the actuator being further arranged to move the foldable lift platform between the vehicle bed and the ground level,
wherein the first connecting mechanism comprises an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position; and
a loading bay comprising a dock lock system, wherein the dock lock system is arranged to cooperate with the rear impact guard of the stow lift system so as to lock the position of the vehicle with respect to the loading bay.

25. The system of claim 24, wherein the rear impact guard is cooperating with the dock lock system.

26. The system of claim 25, wherein the dock lock system comprises at one end a locking mechanism arranged, such that when the vehicle is positioned at the loading bay to engage the rear impact guard at the location of the longitudinal support member so as to lock the position of the vehicle with respect to the loading bay.

27. The system of claim 26, wherein the locking mechanism is hook shaped.

28. A method for fitting a vehicle with a stow lift system, the method comprising the steps of:
providing a stow lift system comprising:
a support frame for mounting the lift system to a vehicle,
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed,
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard,
an actuator for actuating the first connecting mechanism such as to move the platform between the stowed position and the unstowed position, the actuator being further arranged to move the foldable lift platform between the vehicle bed and the ground level,
wherein the first connecting mechanism comprises an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position; and
attaching the stow lift system via the support frame to the rear of the vehicle.

29. A method for locking the position of a vehicle with respect to a loading bay, the method comprising the steps of:
positioning a rear end of the vehicle at a predetermined distance with respect to the loading bay, the vehicle being fitted with a stow lift system comprising:
a support frame for mounting the lift system to a vehicle,
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed,
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard,
an actuator for actuating the first connecting mechanism such as to move the platform between the stowed position and the unstowed position, the actuator being further arranged to move the foldable lift platform between the vehicle bed and the ground level,
wherein the first connecting mechanism comprises an engagement mechanism, such that when the foldable lift platform is moved below level of the rear impact guard, the engagement mechanism engages at least one predetermined location of the rear impact guard such that the actuating force generated by the actuator during the movement of the foldable lift platform is transferred to the rear impact guard so as to overcome the holding force applied to the rear impact guard by the holding mechanism and move the rear impact guard from the extending position to the retracted position;
providing a dock lock system at the loading bay having at one end a locking mechanism; and
positioning the locking mechanism of the dock lock system to the longitudinal support member of the rear impact guard of the stow lift system such that the position of the vehicle with respect to the loading bay is locked during the loading and unloading of products between the loading bay and the vehicle.

30. A method for loading and unloading products to and from a vehicle using a stow lift system, the method comprising the steps of:
providing a vehicle fitted with a stow lift system comprising:
a support frame for mounting the lift system to a vehicle,
a foldable lift platform coupled to the support frame via a first connecting mechanism of the stow lift system, the foldable lift platform being movable by the first connecting mechanism between a stowed position and an unstowed position, when in the unstowed position the foldable lift platform being further movable between the ground level and a vehicle bed,
a rear impact guard comprising a longitudinal support member coupled to the support frame via a second connecting mechanism of the lift system,
a holding mechanism of the lift system arranged between the support frame and the rear impact guard for applying a holding force on the rear impact guard for holding the rear impact guard in an extended position, the rear impact guard being arranged to move from the extended position to a retracted position when the foldable lift platform is lowered below the level of the rear impact guard, the rear impact guard being reversibly movable between the retracted position and the extended position when the foldable lift platform is raised above the level of the rear impact guard,
an actuator for actuating the first connecting mechanism such as to move the platform between the stowed position and the unstowed position, the actuator being further arranged to move the foldable lift platform between the vehicle bed and the ground level; and
unfolding the foldable lift platform so as to form a loading surface;

31. The method of claim 30, the method further comprising the step of positioning the foldable lift platform via the actuators at a first level with respect to the ground level, the first level corresponding to level of a vehicle bed where the products are positioned.

32. The method of claim 31, the method further comprising the step of moving the foldable lift platform from the first level to a second level or the reverse, the second level corresponding to the ground level, such that products can be transferred between the vehicle bed and the ground level.

33. The method of claim 32, wherein the step of moving the lift platform between the first and second levels further comprises the step of moving the rear impact guard from the extended position to the retracted position or the reverse by means of an engagement mechanism of the first connecting mechanism, which is arranged to engage at least one predetermined location of the rear impact guard such that the force generated by the actuator during the movement of the foldable lift platform is transferred to the rear impact guard so as to overcome the holding force applied to the rear impact guard by the holding mechanism and move the rear impact guard from the extending position to the retracted position.
